(19) United States
(12) Patent Application Publication
(10) Pub. No.: US 2024/0092164 A1
(43) Pub. Date: Mar. 21, 2024

(54) SYSTEMS AND METHODS FOR FEATURE ACTIVATION

(71) Applicant: Apple Inc., Cupertino, CA (US)

(72) Inventor: Nicholas G. SAMPLE, Broomfield, CO (US)

(21) Appl. No.: 18/361,682

(22) Filed: Jul. 28, 2023

Related U.S. Application Data
(60) Provisional application No. 63/375,750, filed on Sep. 15, 2022.

(51) Int. Cl. B60K 15/05; B60S 1/08

(52) U.S. Cl. CPC B60K 15/05; B60S 1/0822; B60K 2015/0538

(57) ABSTRACT

In some embodiments, an electronic device selectively activates and deactivates actuation features in accordance with the context in which an electronic device is operating. In some embodiments, an electronic device controls one or more actuators in accordance with sensor data and/or inputs received using one or more input devices.

### CROSS-REFERENCE TO RELATED APPLICATIONS

This application claims the benefit of U.S. Provisional Application No. 63/375,750, filed Sep. 15, 2022, the content of which is incorporated herein by reference in its entirety for all purposes.

### FIELD OF THE DISCLOSURE

Aspects of the present disclosure relate to systems and methods for selectively activating and deactivating actuation features in accordance with the context in which an electronic device is operating.

### BACKGROUND OF THE DISCLOSURE

Electronic devices may control actuators. Control of one or more of these actuators may vary under different device usage scenarios.

### SUMMARY OF THE DISCLOSURE

Aspects of the present disclosure relate to systems and methods for selectively activating and deactivating actuation features in accordance with the context in which an electronic device is operating. In some embodiments, an electronic device controls one or more actuators in accordance with sensor data and/or inputs received using one or more input devices. For example, the electronic device controls movement of doors, activation of wipers, movement of mirrors, access to a charging port, and/or access to a fuel compartment using one or more actuators. In some embodiments, the electronic device detects a context in which the electronic device is operating. In some embodiments, the electronic device selectively activates and deactivates one or more actuator features in accordance with the context in which the electronic device is operating. For example, in certain contexts, the electronic device forgoes moving of doors, activating of wipers, moving of mirrors, providing access to a charging port, and/or providing access to a fuel compartment but in other contexts performs these actions.

While the foregoing and additional implementations are described herein, still other implementations are possible. Modifications within the spirit and scope of the presently disclosed technology are possible. Accordingly, the drawings and detailed description are to be regarded as illustrative in nature.

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1A illustrates an example electronic device operating in a first context according to embodiments of the disclosure.

FIG. 1B illustrates the example electronic device operating in a second context according to embodiments of the disclosure.

FIG. 2 illustrates a block diagram of an example electronic device in accordance with some embodiments.

FIG. 3 illustrates an example method of selective feature activation according to embodiments of the disclosure.

FIG. 4 illustrates an example method of selective feature activation according to embodiments of the disclosure.

### DETAILED DESCRIPTION

Aspects of the present disclosure relate to systems and methods for selectively activating and deactivating actuation features in accordance with the context in which an electronic device is operating. In some embodiments, an electronic device controls one or more actuators in accordance with sensor data and/or inputs received using one or more input devices. For example, the electronic device controls movement of doors, activation of wipers, movement of mirrors, access to a charging port, and/or access to a fuel compartment using one or more actuators. In some embodiments, the electronic device detects a context in which the electronic device is operating. In some embodiments, the electronic device selectively activates and deactivates one or more actuator features in accordance with the context in which the electronic device is operating. For example, in certain contexts, the electronic device forgoes moving of doors, activating of wipers, moving of mirrors, providing access to a charging port, and/or providing access to a fuel compartment but in other contexts performs these actions.

While the foregoing and additional implementations are described herein, still other implementations are possible. Modifications within the spirit and scope of the presently disclosed technology are possible. Accordingly, the drawings and detailed description are to be regarded as illustrative in nature.

While some embodiments of the disclosure are described above and herein, additional and alternative embodiments are possible. Example embodiments are provided in the drawings and detailed description and are illustrative in nature. Modifications to the example embodiments are possible without departing from the scope of the disclosure.

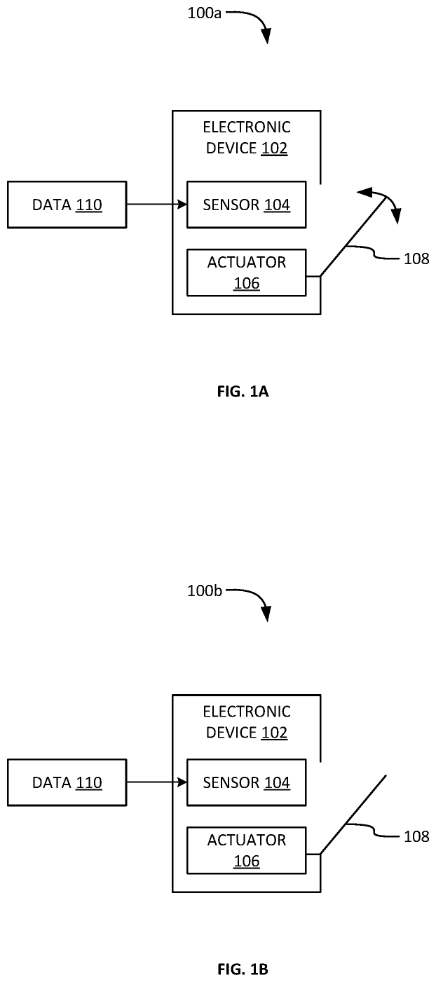

FIG. 1A illustrates an example electronic device 102 operating in a first context 100a according to embodiments of the disclosure. In some embodiments, the electronic device 102 includes a sensor 104 and an actuator 106. In some embodiments, the sensor 104 corresponds to an input device. In some embodiments, the sensor 104 senses data 110 related to articulation of actuator 106. In some embodiments, sensor 104 can detect the context 100a in which the electronic device 102 is operating. In some embodiments, the electronic device 102 uses different sensors for controlling actuator 106 and for detecting context 100a.

In some embodiments, evaluating context 100a includes evaluating a number of characteristics. In some embodiments, context 100a can include a current location of the electronic device 102, a current speed of movement of the electronic device 102, determination that the electronic device 102 is currently located at one of a plurality of recognized scenes, and/or recognition of an object in an image of the current environment of the electronic device 102. For example, in some contexts, such as context 100a, the electronic device 102 controls a door 108 using actuator 106 in response to sensor data 110 corresponding to a request to open, close, and/or reposition the door 108. In this example, context 100a can be a context in which it is likely safe and/or desirable to open the door 108, such as when the electronic device 102 is moving below a threshold speed and/or not at a location in which opening the door would be undesirable, for example, while in a car wash.

In some embodiments, in other contexts, the electronic device 102 does not articulate the actuator 106 in response to sensing data 110 using sensor 104 that would correspond to articulation of the actuator 106 in context 100a.

FIG. 1B illustrates the example electronic device 102 operating in a second context 100b according to embodiments of the disclosure. In some embodiments, context 100b includes a different speed of movement of the electronic device 102, location of electronic device 102, identified scene, and/or identified object in an image of the current environment of electronic device 102 from context 100a.

In some embodiments, while the electronic device 102 is operating in context 100b, in response to sensing data 110 that corresponded to articulating actuator 106 to open door 108 in context 100a, the electronic device forgoes articulating actuator 106. For example, the speed of movement of the electronic device 102 exceeds a predefined threshold in context 100b and is less than the predefined threshold in context 100a. As another example, the electronic device 102 identifies that it is in a car wash in context 100b based on object recognition and/or scene understanding using captured images of the environment of the electronic device 102. In some examples, it may be undesirable to articulate doors, liftgates, fuel doors, mirrors, windows, and/or charge port doors while in a car wash. As another example, the electronic device 102 is configured to articulate wipers in response to detecting moisture data in context 100a but not in context 100b. For example, it may be unnecessary to articulate wipers in a car wash and articulation of wipers in a car wash could cause damage to the wipers and/or to other components of the electronic device 102. In some embodiments moisture data is provided by a water sensor, such as an optical sensor adjacent the windshield, sometimes referred to as a rain sensor.

In some embodiments, the electronic device 102 uses sensor 104 to detect the context (e.g., context 100a or context 100b) in which the electronic device 102 is operating. In some embodiments, the electronic device 102 uses the same sensor 104 to identify the operating context and to control articulation of actuator 106. In some embodiments, the electronic device 102 uses different sensors for identifying the operating context than the sensor 104 used to control articulation of actuator 106.

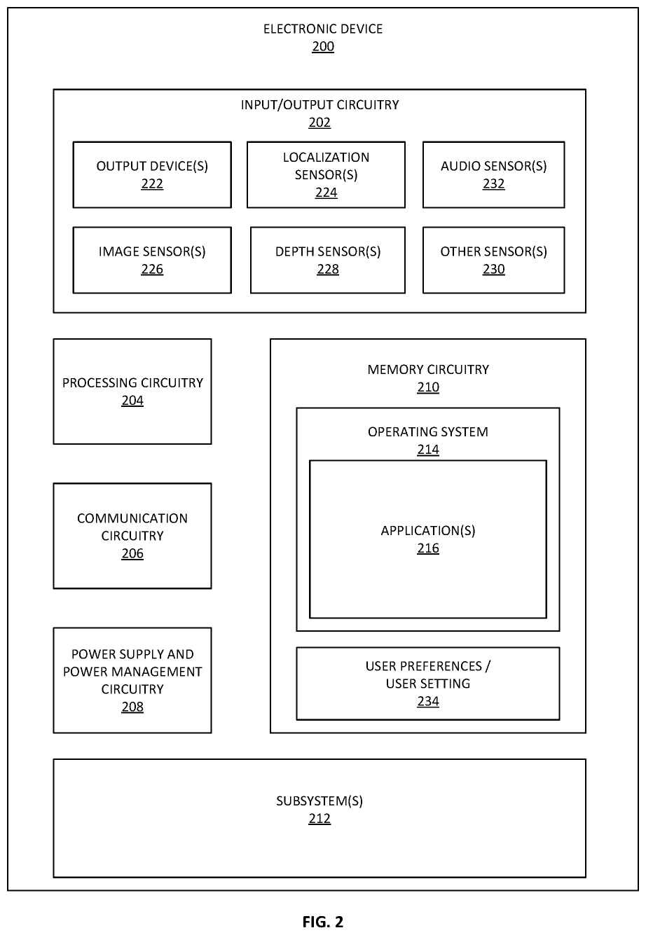

FIG. 2 illustrates a block diagram of an example electronic device 200 in accordance with some embodiments. Electronic device 200 can represent electronic device 102 in FIGS. 1A-1B shown in more detail. It is understood that the block diagram of FIG. 2 includes one example architecture, but that a different electronic device may have more or fewer components and/or a different configuration of components than shown in FIG. 2. For instance, one or more of electronic device(s) 102, 114, and/or 116 may include additional components not illustrated in FIG. 2 and/or may exclude one or more components illustrated in FIG. 2. Various components of FIG. 2 can be implemented in hardware, software, firmware or combinations thereof.

As illustrated, FIG. 2 can include input/output circuitry 202, processing circuitry 204, communication circuitry 206, power supply and power management circuitry 208, memory circuitry 210 and one or more subsystems 212. Although not shown in FIG. 2, the various components can be electrically coupled by one or more buses and/or using one or more interfaces and electrical connections.

Input/output circuitry 202 can include devices for providing input to the electronic device 200 and for providing output from the electronic devices. In some examples, input/output circuitry 202 can include sensors such as localization sensor(s) 224, image sensor(s) 226, depth sensor(s) 228, audio sensor(s) 232, and other sensor(s) 230 and/or one or more output device(s) 222. In some embodiments, sensor 104 in FIGS. 1A-1B corresponds to localization sensor(s) 224, image sensor(s) 226, depth sensor(s) 228, audio sensor(s) 232, and/or other sensor(s) 230 in FIG. 2. In some embodiments, the first device 102 uses one or more of localization sensor(s) 224, image sensor(s) 226, depth sensor(s) 228, audio sensor(s) 232, and other sensor(s) 230 to sense sensor data (e.g., to determine whether to articulate actuator 106 in FIGS. 1A-1B) and/or to determine the context (e.g., context 100a in FIG. 1A or context 100b in FIG. 1B) in which the first device 102 is operating.

Output device(s) 222 can include display device(s), speaker(s), and/or haptic output devices in communication with or integrated with electronic device 200 that provide visual, audio, and/or tactile feedback, respectively, to the user. Localization sensor(s) 224 may be used to determine location, heading, and/or orientation of electronic device 200. The localization sensor(s) 224 or localization system(s) can include global navigation satellite system (GNSS) or sensor, inertial navigation system (INS) or sensor, global positioning system (GPS) or sensor, altitude and heading reference system (AHRS) or sensor, compass, etc. Image sensor(s) 226 and depth sensor(s) 228 can include sensors to generate two-dimensional or three-dimensional images, radio detection and ranging sensors or systems, light detection and ranging sensors or systems, visual or video detection and ranging sensors or systems, infrared (IR) sensors, optical sensors, camera sensors (e.g., color or grayscale), etc. Audio sensor(s) 232 can include one or more microphones, optionally arranged in an array. It is understood that additional input/output devices can be included in the electronic devices described herein, such as a keyboard, a mouse, a button, a slider, a touch sensor or touch sensor panel, a wheel, a touchpad, a trackpad, a touch screen, a joystick, a proximity sensor, a switch, etc.

Processing circuitry 204 can include one or more processors including microcontrollers, microprocessors, application specific integrated circuits (ASICs), programmable logic device (PLD), field-programmable gate arrays (FPGAs), central processing units (CPUs), graphics processing units (GPUs), digital signal processors (DSPs), or any suitable processing circuitry. Processing circuitry 204 can be used to perform any of the processes, methods, or functions described herein (e.g., optionally by executing instructions or programs stored in a non-transitory computer-readable storage medium). Some example functions include receiving user inputs, communicating with other electronic devices, sensing data, generating indications and/or determining the context in which the electronic device is operating.

Communication circuitry 206 can include circuitry to provide for wired or wireless communication with other electronic devices, such as between electronic devices 102a, 114, and/or 120 included in system 100. In some examples, the communication circuitry can enable communication using different communication protocols such as WiFi, Bluetooth, Zigbee, cellular, satellite, etc. In some examples, the communication circuitry can include one or more transmitter and/or receiver antennas to transmit and/or receive data from one or more data sources for use in predictive actions as described herein.

In some examples, power supply and power management circuitry 208 can include one or more energy storage device(s) (e.g., a battery or multiple batteries) to provide a power supply for the powered components of electronic device 200. In some examples, power supply and power management circuitry 208 can include circuitry for wired or wireless charging of the one or more energy storage device(s). In some examples, the power supply and power management circuitry 208 can include circuitry to manage power delivery and usage by the components of electronic device 200, to manage charging of the one or more energy storage device(s), and/or to monitor the energy levels of the one or more energy storage devices.

Memory circuitry 210 can include any suitable type of memory including but not limited to volatile or non-volatile memory (e.g., where data may be maintained after all power is removed from electronic device 200). Memory circuitry 210 can include any suitable electronic, magnetic, optical, electromagnetic, infrared, or semiconductor system, apparatus or device. The memory circuitry can include, but is not limited to, flash memory devices, random access memory (RAM) devices (e.g., dynamic random-access memory (DRAM), static random-access memory (SRAM), double-data-rate random-access memory (DDR RAM), or other high-speed RAM or solid-state RAM, etc.), read-only memory (ROM) devices, or erasable or electrically erasable programmable read-only memory devices (EPROM or EEPROM). In some examples, some of memory circuitry 210 can be integrated within other components of electronic device 200. In some examples, memory circuitry 210 can be separate from the one or more other components of electronic device 200 and electrically coupled for read and/or write operations.

In some examples, the memory circuitry 210 or a subset of the memory circuitry 210 can be referred as a computer-readable storage medium. Memory circuitry 210 and/or the non-transitory computer readable storage medium of memory circuitry 210 can store programs, instructions, data modules, data structures or a subset or combination thereof. In some examples, Memory circuitry 210 and/or the non-transitory computer readable storage medium can store an operating system 214. In some examples, the operating system 214 can manage one or more running applications 216 (e.g., by scheduling the electronic device 200 to execute the applications 216 using one or multiple processing cores). Additionally, memory circuitry 210 and/or non-transitory computer readable storage medium can have programs/instructions stored therein, which when executed by processing circuitry, can cause the electronic device 200 (or the computing system more generally) to perform one or more functions and methods of one or more examples of this disclosure (e.g., determining whether or not to perform a maneuver and/or whether or not to update a movement algorithm of the device). As used herein, a “non-transitory computer-readable storage medium” can be any tangible medium (e.g., excluding signals) that can contain or store programs/instructions for use by the electronic device (e.g., processing circuitry).

Subsystems 212 can include any additional subsystems for electronic device 200. In some embodiments, subsystem(s) 212 include actuator 106 in FIGS. 1A-1B. For some mobile devices, subsystems 212 can include, without limitation, motor controllers and systems, additional or alternative actuators, light systems, navigation systems, entertainment systems, and the like.

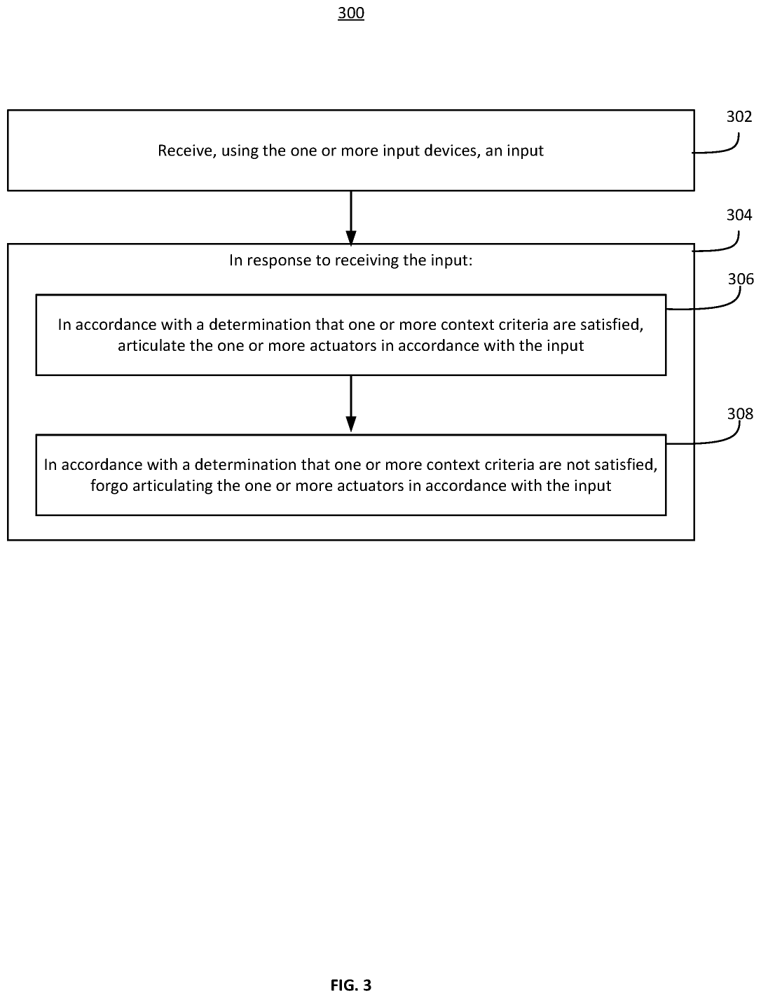

FIG. 3 illustrates an example method 300 of selective feature activation according to embodiments of the disclosure. In some embodiments, method 300 is performed by electronic device 102 in FIGS. 1A-1B and/or electronic device 200 in FIG. 2.

In some embodiments, the method 300 includes receiving 302, using the one or more input devices (e.g., sensor 104), an input (e.g., data 110). For example, an input device includes a sensor 104 that senses data 110 and the electronic device 102 detects inputs based on the data 110 sensed by the sensor 104 included in the input device. In some embodiments, the method 300 includes in response to receiving the input 304, in accordance with a determination that one or more context criteria are satisfied (e.g., the electronic device 102 is operating in context 100a), articulating 306 the one or more actuators (e.g., actuator 106) in accordance with the input. In some embodiments, the method 300 includes in response to receiving the input 304, in accordance with a determination that one or more context criteria are not satisfied (e.g., the electronic device 102 is operating in context 100b), forgo 308 articulating the one or more actuators (e.g., actuator 106) in accordance with the input.

In some embodiments, the one or more context criteria include a criterion that is satisfied based on a current location of the electronic device. In some embodiments, the one or more context criteria include a criterion that is satisfied based on a current speed of movement of the electronic device. In some embodiments, the one or more context criteria include a criterion that is satisfied based on a determination, using sensed data, that the electronic device is located at one of a plurality of recognized scenes. In some embodiments, an electronic device further includes one or more cameras and the one or more context criteria include a criterion that is satisfied based on identifying an object included in an image of current surroundings of the electronic device captured using the one or more cameras. In some embodiments, the actuator is an actuator to open a door controlled by the electronic device. In some embodiments, the one or more input devices include a door handle sensor. In some embodiments, the input corresponds to a request to open the door. In some embodiments, the actuator is an actuator to open a door controlled by the electronic device. In some embodiments, the one or more input devices include a motion sensor. In some embodiments, receiving the input includes detecting, using the motion sensor, motion data corresponding to a request to open the door. In some embodiments, the actuator is an actuator controlling access of a charging port of the electronic device. In some embodiments, the input corresponds to a request to access the charging port. In some embodiments, the actuator is an actuator controlling access to a fuel door controlled by the electronic device. In some embodiments, the input corresponds to a request to access the fuel door. In some embodiments, the one or more input devices include a water sensor. In some embodiments, the actuator is an actuator to activate wipers controlled by the electronic device in accordance with moisture data sensed using the water sensor. In some embodiments, receiving the input includes detecting, using the water sensor, moisture data corresponding to activation of the wipers. In some embodiments, the actuator is an actuator to reposition a mirror controlled by the electronic device in accordance with an input received using the one or more input devices. In some embodiments, the input corresponds to a request to reposition the mirror.

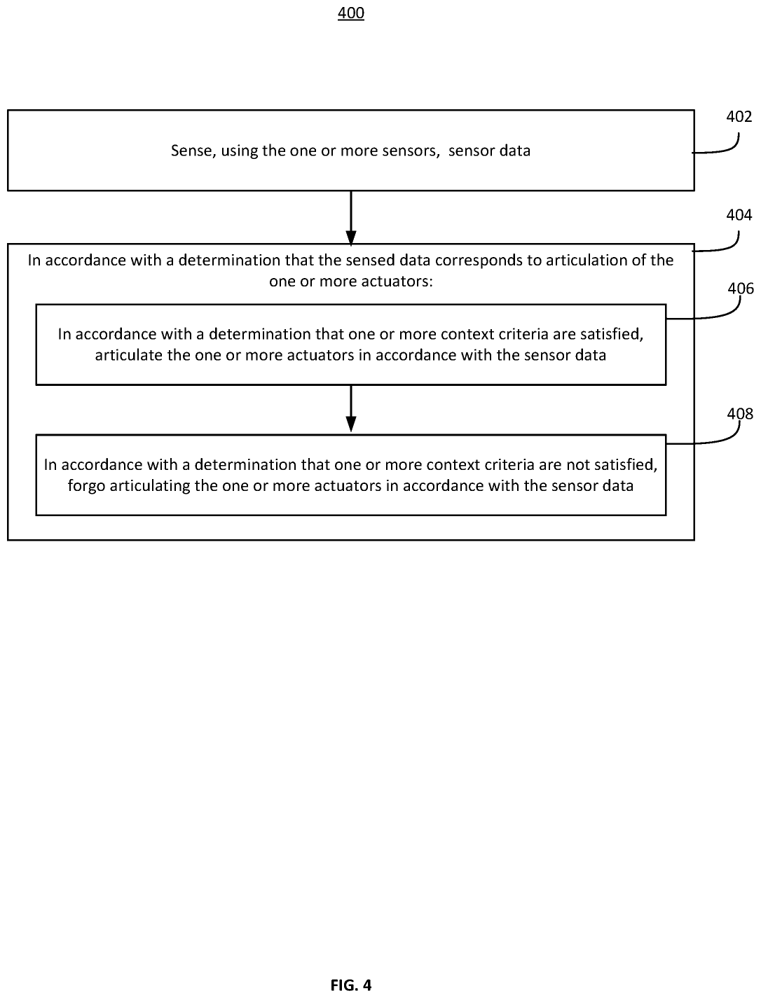

FIG. 4 illustrates an example method 400 of selective feature activation according to embodiments of the disclosure. In some embodiments, method 400 is performed by electronic device 102 in FIGS. 1A-1B and/or electronic device 200 in FIG. 2.

In some embodiments, the method 400 includes sensing 402 data (e.g., data 110) using the one or more sensors (e.g., sensor 104). In some embodiments, the method 400 includes in accordance with a determination that the sensed data (e.g., data 110) corresponds to articulation of the one or more actuators (e.g., actuator 106) 404, in accordance with a determination that one or more context criteria are satisfied (e.g., the electronic device 102 is operating in context 100a), articulating 406 the one or more actuators (e.g., actuator 106) in accordance with the sensed data (e.g., data 110). In some embodiments, the method 400 includes in accordance with a determination that the sensed data (e.g., 110) corresponds to articulation of the one or more actuators (e.g., actuator 106) 404, in accordance with a determination that one or more context criteria are not satisfied (e.g., the electronic device 102 is operating in context 100b), forgoing 408 articulating the one or more actuators (e.g., 106) in accordance with the sensed data (e.g., 110).

In some embodiments, the one or more context criteria include a criterion that is satisfied based on a current location of the electronic device. In some embodiments, the one or more context criteria include a criterion that is satisfied based on a current speed of movement of the electronic device. In some embodiments, the one or more context criteria include a criterion that is satisfied based on a determination, using sensed data, that the electronic device is located at one of a plurality of recognized scenes. In some embodiments, an electronic device includes one or more cameras and the one or more context criteria include a criterion that is satisfied based on identifying an object included in an image of current surroundings of the electronic device captured using the one or more cameras. In some embodiments, the one or more processors are further configured to sense second data using the one or more sensors, wherein determining that one or more context criteria are satisfied or not satisfied is based on the second sensed data. In some embodiments, the actuator is an actuator to open a door controlled by the electronic device. In some embodiments, the one or more sensors include a door handle sensor. In some embodiments, determining that the sensed data corresponds to articulation of the one or more actuators includes determining that the sensed data corresponds to a request to open the door. In some embodiments, the actuator is an actuator to open a door controlled by the electronic device. In some embodiments, the one or more sensors include a motion sensor. In some embodiments, determining that the sensed data corresponds to articulation of the one or more actuators includes determining that the sensed data corresponds to a request to open the door. In some embodiments, the actuator is an actuator controlling access to a charging port the electronic device. In some embodiments, determining that the sensed data corresponds to articulation of the one or more actuators includes determining that the sensed data corresponds to a request to access the charging port. In some embodiments, the actuator is an actuator controlling access to a fuel door controlled by the electronic device. In some embodiments, determining that the sensed data corresponds to articulation of the one or more actuators includes determining that the sensed data corresponds to a request to access the fuel door. In some embodiments, the one or more sensors include a water sensor. In some embodiments, the actuator is an actuator to activate wipers controlled by the electronic device in accordance with moisture data sensed using the water sensor. In some embodiments, determining that the sensed data corresponds to articulation of the one or more actuators includes determining that the water data corresponds to activation of the wipers. In some embodiments, the actuator is an actuator to reposition a mirror controlled by the electronic device in accordance with the sensed data. In some embodiments, determining that the sensed data corresponds to articulation of the one or more actuators includes determining that the sensed data corresponds to a request to reposition the mirror.

Technology implementors are reminded that the collecting sensor data in the physical environment of the electronic device should be performed in accordance with privacy practices meeting or exceeding applicable laws and/or industry standards. These privacy practices may include, but are not limited to, requiring user permission to share the data and/or permitting the user to opt-out of processing and/or storing some or all of the data and/or anonymizing the data, and so forth. For example, implementers of devices may explain in its user interface and documentation the devices ability to sense data, and require appropriate parties to opt-in before accepting incoming data sensing requests.

1. An electronic device comprising:
one or more input devices;
one or more actuators;
memory; and
one or more processors coupled to the one or more input devices, the one or more actuators, and the memory, the one or more processors configured to:
receive, using the one or more input devices, an input;
in response to receiving the input:
in accordance with a determination that one or more context criteria are satisfied, articulate the one or more actuators in accordance with the input; and
in accordance with a determination that one or more context criteria are not satisfied, forgo articulating the one or more actuators in accordance with the input.

2. The electronic device of claim 1, wherein the one or more context criteria include a criterion that is satisfied based on a current location of the electronic device.

3. The electronic device of claim 1, wherein the one or more context criteria include a criterion that is satisfied based on a current speed of movement of the electronic device.

4. The electronic device of claim 1, wherein the one or more context criteria include a criterion that is satisfied based on a determination, using sensed data, that the electronic device is located at one of a plurality of recognized scenes.

5. The electronic device of claim 1 further comprising:
one or more cameras, wherein the one or more context criteria include a criterion that is satisfied based on identifying an object included in an image of current surroundings of the electronic device captured using the one or more cameras.

6. The electronic device of claim 1, wherein:
the actuator is an actuator to open a door controlled by the electronic device;
the one or more input devices include a door handle sensor; and
the input corresponds to a request to open the door.

7. The electronic device of claim 1, wherein:
the actuator is an actuator to open a door controlled by the electronic device;
the one or more input devices include a motion sensor; and
receiving the input includes detecting, using the motion sensor, motion data corresponding to a request to open the door.

8. The electronic device of claim 1, wherein:
the actuator is an actuator controlling access of a charging port of the electronic device; and
the input corresponds to a request to access the charging port.

9. The electronic device of claim 1, wherein
the actuator is an actuator controlling access to a fuel door controlled by the electronic device; and
the input corresponds to a request to access the fuel door.

10. The electronic device of claim 1, wherein:
the one or more input devices include a water sensor;
the actuator is an actuator to activate wipers controlled by the electronic device in accordance with moisture data sensed using the water sensor; and
receiving the input includes detecting, using the water sensor, moisture data corresponding to activation of the wipers.

11. The electronic device of claim 1, wherein:
the actuator is an actuator to reposition a mirror controlled by the electronic device in accordance with an input received using the one or more input devices; and
the input corresponds to a request to reposition the mirror.

12. A method performed at an electronic device including one or more input devices, one or more actuators, memory, and one or more processors coupled to the one or more input devices, the one or more actuators, and the memory, the method comprising:
receiving, using the one or more input devices, an input;
in response to receiving the input:
in accordance with a determination that one or more context criteria are satisfied, articulating the one or more actuators in accordance with the input; and
in accordance with a determination that one or more context criteria are not satisfied, forgoing articulating the one or more actuators in accordance with the input.

13. A non-transitory computer readable storage medium storing instructions that, when executed by an electronic device including one or more input devices, one or more actuators, memory, and one or more processors coupled to the one or more input devices, the one or more actuators, cause the electronic device to:
receive, using the one or more input devices, an input;
in response to receiving the input:
in accordance with a determination that one or more context criteria are satisfied, articulate the one or more actuators in accordance with the input; and
in accordance with a determination that one or more context criteria are not satisfied, forgo articulating the one or more actuators in accordance with the input.

14. The non-transitory computer readable storage medium of claim 13, wherein the electronic device further includes one or more cameras, and the one or more context criteria include a criterion that is satisfied based on identifying an object included in an image of current surroundings of the electronic device captured using the one or more cameras.

15. The non-transitory computer readable storage medium of claim 13, wherein:
the actuator is an actuator to open a door controlled by the electronic device;
the one or more input devices include a door handle sensor; and
the input corresponds to a request to open the door.

16. The non-transitory computer readable storage medium of claim 13, wherein:
the actuator is an actuator to open a door controlled by the electronic device;
the one or more input devices include a motion sensor; and
receiving the input includes detecting, using the motion sensor, motion data corresponding to a request to open the door.

17. The non-transitory computer readable storage medium of claim 13, wherein:
the actuator is an actuator controlling access of a charging port of the electronic device; and
the input corresponds to a request to access the charging port.

18. The non-transitory computer readable storage medium of claim 13, wherein:
the actuator is an actuator controlling access to a fuel door controlled by the electronic device; and
the input corresponds to a request to access the fuel door.

19. The non-transitory computer readable storage medium of claim 13, wherein:
the one or more input devices include a water sensor;
the actuator is an actuator to activate wipers controlled by the electronic device in accordance with moisture data sensed using the water sensor; and
receiving the input includes detecting, using the water sensor, moisture data corresponding to activation of the wipers.

20. The non-transitory computer readable storage medium of claim 13, wherein:
the actuator is an actuator to reposition a mirror controlled by the electronic device in accordance with an input received using the one or more input devices; and
the input corresponds to a request to reposition the mirror.
